(19) United States
(12) Patent Application Publication
(10) Pub. No.: US 2023/0362581 A1
(43) Pub. Date: Nov. 9, 2023

(54) IOT MESH SYSTEM

(71) Applicant: Bluetooth Mesh Solutions Limited, London (GB)

(72) Inventor: Richard Brooks, London (GB)

(21) Appl. No.: 18/028,384

(22) PCT Filed: Sep. 24, 2021
(86) PCT No.: PCT/GB2021/052486

§ 371 Date: Mar. 24, 2023

(30) Foreign Application Priority Data
Sep. 25, 2020 (GB) 2015193.2

(51) Int. Cl. H04W 4/021; H04W 4/38; H04W 4/44

(52) U.S. Cl. CPC H04W 4/021; H04W 4/38; H04W 4/44; H04W 84/18

(57) ABSTRACT

An IOT mesh system for smart cities is disclosed, the system comprising at least one primary module and a plurality of secondary modules suitable for on-street use. The secondary modules are configured to communicate with each other and with the at least one primary module using a wireless mesh communications protocol. The at least one primary module is configured to communicate with a control server using a low power wide area network, LEW AN, communications protocol. In particular examples, one or more of the modules are vehicle sensors.

### FIELD OF THE INVENTION

The invention relates to an IOT mesh system for smart cities comprising networked external/smart city devices. In particular, the invention relates to an IOT mesh system comprising vehicle detectors.

### BACKGROUND

The ill-effects of vehicle pollution and congestion in towns and cities is increasingly being recognised. Indeed, it has been suggested that increased vehicle pollution is associated with worse outcomes from Covid-19. A significant portion of that pollution and congestion is caused by vehicles searching for a place to park. It has been estimated that 10% of the time of an average journey is spent looking for a parking spot. Providing information about which parking spots are available can help reduce this time, and so reduce pollution and congestion.

The power of collecting other on-street data is also increasingly recognised. City managers may want to access measurements such as air quality and temperature in real time. The more on-street sensors available, the better the city can be managed. Such on-street sensors may be termed smart city devices.

### SUMMARY OF THE INVENTION

According to a first aspect of the invention there is provided an IOT mesh system comprising:
at least one primary module for on-street use; and
a plurality of secondary modules configured to communicate with each other and with the at least one primary module using a wireless mesh communications protocol, each secondary module for on-street use;
wherein the at least one primary module is configured to communicate with a control server using a low power wide area network, LPWAN, communications protocol.

The IOT mesh system may be considered a street management system—i.e. a system suitable for street-like environments. Such environments may be both ‘on-street’ and ‘off-street’ (such as car parks)—i.e. both private and public outside space. Similarly, the primary and secondary modules may be considered to be on-street modules in that they are suitable for use in or on street-like external environments, including on streets and in off-street spaces such as car parks. In the following, the term ‘on-street’ is used generally to indicate devices positionable in street-like environments, including off-street locations such as car parks.

As discussed above, there is a need for ever more on-street/smart city devices to provide real time information to individuals on the street or to city managers. In conventional systems, each sensor of interest is installed ad-hoc, with its own independent connection to a control server—if it has any remote connection at all. The present invention provides a single street management system that can be used to connect large numbers of on-street devices, and different types of on-street device. By using a wireless mesh network, individual devices are able to transmit messages to the control server via neighbouring devices, allowing individual devices to transmit much lower power signals than would otherwise be possible. Low power consumption is a key benefit in a system designed to be placed on-street, spread across wide areas—allowing cheaply installed, low maintenance, battery-powered devices to be used. The combination of wireless mesh network with LPWAN communications from the primary modules has been found to provide reliable communications across wide areas in towns and cities—where buildings and other street furniture can interfere with transmitted signals in unusual and non-uniform ways.

In some embodiments, the wireless mesh communications protocol may operate in the 2.4 GHz band. This band has been found to be particularly reliable in on-street settings when using only low-power signals.

In some embodiments, one or more of the at least one primary modules, and/or one or more of the plurality of secondary modules may be vehicle sensors configured to detect the presence of a vehicle at a location associated with the respective primary or secondary module. In other words, any of the modules may be a parking sensor/parking space occupancy detector/vehicle detector.

In some embodiments, at least one of the plurality of modules (either primary or secondary modules) may be a smart city device such as an air quality monitor, temperature sensor, or solar intensity sensor. The modules may comprise combinations of different smart city devices. Thus the street management system is able to link together a range of different device types, providing a single network infrastructure for smart city management.

In some embodiments, the system may be configured to:
receive a request from an additional module to access the system;
authenticate, via one of the at least one primary modules, the additional module with the control server;
receive, via one of the at least one primary modules, confirmation from the control server that the additional module is authenticated; and
allow the additional module to access the system as a secondary module.

Authentication of the additional module may for example comprise receiving a unique identifier associated with the additional module, determining if the unique identifier is in a list of pre-approved modules or is associated with a pre-approved module operator, and if so authenticating the additional module.

Such embodiments allow further modules, of any device type, to be easily added into an existing network, allowing the system to expand and evolve over time.

In some embodiments, the system may further comprise the control server.

In embodiments in which at least one module is a vehicle sensor, the control server may be configured to communicate with a navigation system associated with a first vehicle, or an occupant of the first vehicle, to direct the first vehicle to a specified module of the at least one primary modules and plurality of secondary modules. The specified module may be configured to detect arrival of the first vehicle at a location associated with the specified module, and to report the arrival of the first vehicle to the control server.

The navigation system may be a navigation system (e.g. GPS system) of the first vehicle, for example an in-car navigation system. Alternatively the navigation system may be a navigation system of a portable electronic device such as a smart phone, associated with or present in the first vehicle. For example, the electronic device may be the driver's electronic device. In some embodiments, the control server may communicate with an app on a smart phone. The smart phone may provide directions to the driver directly, or may communicate with an in-vehicle system to provide directions.

In some embodiments, the first vehicle may be an autonomous vehicle.

Such embodiments use the on-street mesh/LPWAN network to provide information on available parking spaces, and then direct a vehicle directly to that parking space. This avoids unnecessary searching for a parking space, reducing pollution and congestion. Furthermore, where the vehicle is an autonomous vehicle, such embodiments may provide instructions that are directly acted on by the vehicle to drive to the intended space.

It is possible that the rise of autonomous vehicles, in particular autonomous taxis/rentable vehicles, will cause a rise in congestion in cities as the vehicles drive around waiting for a user. The present invention may limit this congestion. For example, the control server may be an autonomous vehicle control server. The control server may be configured to determine whether an autonomous vehicle is in use, and if not (e.g. has not been in use for longer than a predetermined period of time), may instruct the vehicle to proceed to a specified parking space by selecting an available on-street parking module. The autonomous vehicle may then hold in the parking space until needed, preventing the vehicle from adding to congestion. In particular, the server may determine, based on demand/supply of autonomous vehicles in the local area, when to release a parked vehicle.

In some embodiments, upon receipt of the report of arrival of the first vehicle, the control server may be configured transmit a notification to the first vehicle, or to a user of the first vehicle. For example, the notification may inform the user of conditions of using the parking space, or provide for payment for the parking space. Alternatively, the notification may be an autonomous vehicle control signal, for example instruction the autonomous vehicle to remain at the parking space for a particular period of time.

In some embodiments, the notification may be dependent upon at least one of: the location of the specified module, and a time of arrival of the first vehicle at the specified module. For example, where the notification is dependent upon the location of the specified module, the control server is configured to: determine an identifier of the specified module; determine a geographical location associated with the identifier; and generate a notification based at least in part on the determined geographical location. In this way, the control server is able to provide unique notifications to the first vehicle (or an occupant thereof) based on the geographic location, or conditions associated with that location. Such a notification may for example inform the occupant of shops or services available within a predetermined distance of the parking space. In some embodiments, such a notification may include offers for the occupant to use in the nearby shops or services. Alternatively, the location-dependent notification may be an autonomous vehicle control signal, for example instructing the vehicle to remain in the parking space for a particular period of time based on current or predicted congestion within the vicinity of the location.

In some embodiments, the specified module may be selected by the occupant of the first vehicle.

In some embodiments, the specified module may be selected by the control server from the at one least primary module and plurality of secondary modules based on status reports received from each of the at one least primary module and plurality of secondary modules, each status report indicating the presence or absence of a vehicle in a respective location associated with a respective primary or secondary module.

In some such embodiments, the occupant of the first vehicle may select a module, but that module may become unavailable before the first vehicle arrives at the selected module. The control server may then select an alternative available specified module, and direct the first vehicle to that alternative module (e.g. by informing a smart device of the driver/a vehicle occupant, which may direct the driver directly, or communicate with the vehicle's systems to direct the driver to the alternative parking space). For example, the alternative module may be an available module with the shortest travel time from the occupant-selected module.

In some embodiments, wherein the specified module is a secondary module, the secondary module may be configured to transmit a status report indicating arrival of the first vehicle to a nearest primary module via one or more intermediary secondary modules in accordance with the wireless mesh communications protocol. The nearest primary module may be configured to, upon receipt of the status report indicating arrival of the first vehicle, transmit the status report to the control server using the LPWAN communications protocol. In other words, the status report is transmitted through the mesh network until it reaches a primary module, which uses its LPWAN connection to convey the status report to the control server.

According to a second aspect of the invention, there is provided a method of directing a vehicle to a parking location, the method comprising:
receiving status reports from a plurality of secondary modules of an IOT mesh or street management system, the system comprising a plurality of secondary modules and at least one primary module, each status report indicating the presence or absence of a vehicle at a parking location associated with the respective secondary module, wherein:
   each status report is received via a wireless mesh network formed by the plurality of secondary modules and a primary module, and via a LPWAN communication link with the primary module;
identifying a sub-set of secondary modules reporting absence of a vehicle;
identifying a target module from the sub-set of secondary modules;
communicating with a navigation system of a vehicle to direct the vehicle to the target module; and
receiving, via the wireless mesh network and LPWAN communication link, a report indicating arrival of the vehicle at the target module.

In some embodiments, identifying a target module from the sub-set of secondary modules may comprise:
receiving, from the navigation system associated with the vehicle, a request for parking at an intended destination;
selecting one of the sub-set of secondary modules based on distance or travel time between the selected module and the intended destination, and/or based on a dynamic cost factor associated with each module; and
identifying the selected module as the target module.

In other words, the parking space may be automatically selected for the vehicle or occupant thereof. The dynamic cost factor may be a price paid for parking in a particular parking bay, which may be dynamically adjusted based on a current demand/supply of parking spaces, to limit the number of vehicles (and associated pollution) in a particular area. Alternatively or additionally, the dynamic cost factor may be dynamically adjusted on pollutant emissions of the individual vehicle (e.g. CO₂ emissions), or current pollutant levels in the area around a particular module.

In some embodiments, identifying a target module from the sub-set of secondary modules comprises receiving, from the navigation system associated with the vehicle, a request for parking, wherein the request specifies the target module. In other words, the vehicle or occupant thereof may specify a particular module/parking space, and is directed to that specified module.

The method may further comprise performing any of the steps associated with the navigation embodiments of the first aspect discussed above.

According to a third aspect of the invention there is provided a computer program or computer readable medium comprising instructions which, when executed by a computer (e.g. by a processer of a control server), cause the computer to perform the method of any embodiment of the second aspect.

### BRIEF DESCRIPTION OF THE DRAWINGS

By way of example only, certain embodiments of the invention shall now be described by reference to the accompanying drawings, in which:

FIG. 1 is a schematic representation of an exemplary IOT mesh system for smart cities;

FIG. 2 illustrates a process of adding additional modules to the system;

FIGS. 3a and 3b illustrates an IOT mesh system used to direct a vehicle to a parking space; and

FIG. 4 illustrates a method of directing a vehicle to a parking space using an IOT mesh system according to the present disclosure.

### DETAILED DESCRIPTION

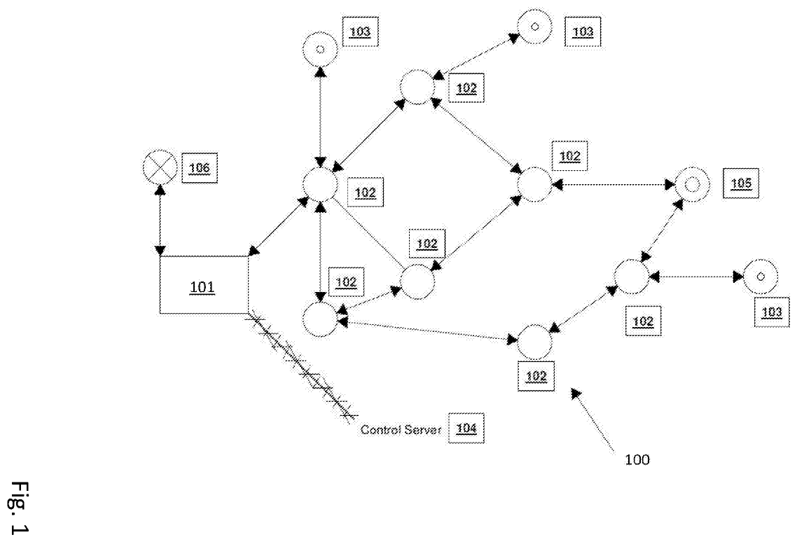

FIG. 1 illustrates an example of an IOT mesh system 100 suitable for use in smart cities (i.e. built-up or urban areas employing internet connected devices). System 100 may be considered to be a street management system. System 100 comprises a primary module 101, and a plurality of secondary modules 102, 103. Modules 101-103 are electronic devices installed, or capable of being installed, in a street-like (primarily outside) environment, such as a town street, a city street, or a car park. As discussed above, such environments provide unique challenges to provision of smart devices. System 100 seeks to provide a low-power, low-maintenance, low-cost, and flexible network of on-street devices to improve town/city management. Although described as suitable for smart cities, it is to be noted that the systems described herein may also be used in non-urban settings, for example smaller towns and villages in rural areas. Moreover, although primarily intended for external use, it is to be noted that the systems described herein may be used in covered or multi-story car parks—which are still street-like environments in that they are designed for movement and parking of vehicles.

Primary module 101 is configured to communicate with a remote control server 104 via a low power wide area network (LPWAN) connection (represented by the crossed communication line in FIG. 1). The LPWAN connection may for example be based on narrow band-internet of things (NB-IOT) or LoRa protocols, both of which provide low power communications with the control server 104. The primary module 101 may use the LPWAN communications link for example to transmit status reports from any of the modules 101-103 (e.g. car parking space availability), and to receive instructions for any of the modules 101-103 from the control server 104. The control server may be part of the system 100, or may be external to the system 100.

The secondary modules 102, 103 form a mesh network with each other and with the primary module 101. Secondary modules 102 may be considered relay modules. As well as transmitting their own signals (e.g. based on the car parking availability of that relay module), the relay modules receive signals from other secondary modules 102, and relay them either to a further relay module, or to the primary module 101. When a signal reaches the primary module 101, it is transmitted to the control server 104 over the LPWAN connection, as discussed above. Secondary modules 103 may be considered node modules. Node modules only transmit signals, they do not receive and transmit signals. However, the node modules may be capable of acting as relay modules, for example if the system 100 is expanded with further modules 101-103; or if the mesh network dynamically rearranges based on changing conditions (e.g. loss of connection with a different module 101-103).

In general, a secondary module 102, 103 transmits signals (either its own or relayed signals) to the module 101-102 that requires the lowest power signal to reach. For example, this may be the geographically nearest module 101-102, or the module 101-102 that ‘sounds loudest’ to the first module 102—i.e. has the highest strength communication link with the first module 102. The choice of module 101,102 may dynamically change based on current circumstances. For example, modules 101, 102 may go offline, or changing environmental circumstances may reduce the signal strength with a particular module 101, 102. In this way, the mesh network of modules 101-103 dynamically reacts to changing circumstances to provide a reliable, low-power communications system, well-suited to the ever-changing on-street environment.

In particular embodiments, the secondary modules 102, 103 may communicate with each other and with the primary module/s 101 using a protocol operating in the 2.4 GHz band. This has been found to provide reliable and low-power communications in the on-street environment. In particular implementations, the 2.4 GHz communications protocol provided by Wirepas (RTM) may be used.

In the illustrated embodiment of system 100, modules 101-103 are vehicle sensors. The vehicle sensors detect the presence of a vehicle at a particular location, for example in a particular parking space. For example, the vehicle sensors may be affixed to or embedded in a road surface or car park surface, and may detect the presence of a vehicle above them. In the present invention, these vehicle sensors themselves form the mesh network and provide communications with the control server—there is no need for dedicated relay hardware, for example. This reduces costs, and amount of space required for installation of the system.

The illustrated system 100 further comprises a smart city sensor 105, such as an air quality sensor. The smart city sensor 105 forms part of the mesh network, just like any other secondary module. It can send signals through the mesh and LPWAN connections to the control sever 104 (or to a different control sever, such as a control server dedicated to the function of that smart city sensor, rather than a parking space vehicle detector). In the illustrated example, the smart city sensor 105 is shown as a node module, but it could also be a relay module, or a primary module capable of LPWAN communications. Thus the single on-street network formed by system 100 allows different types of on-street device to communicate with each other, and with control servers. Again, this reduces costs and space requirements—as there is no need for separate communications infrastructure for each on-street device type.

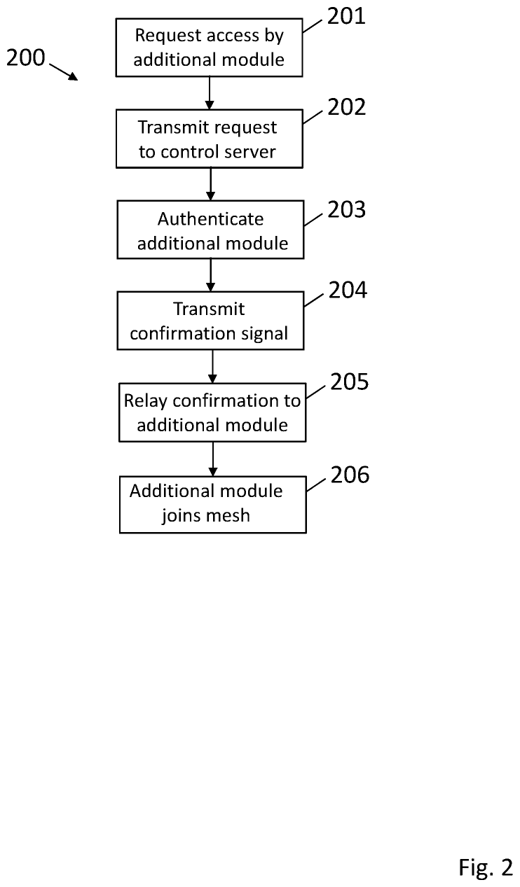

FIG. 1 shows an additional module 106. Additional module 106 is in the process of being added to system 100. For example, additional module 106 may be a newly installed vehicle detector/parking sensor or smart city device. Before additional module 106 can be given full access to system 100, it must be authenticated. FIG. 2 illustrates a method for authenticating a newly installed module.

Method 200 starts at step 201. At step 201 the additional module 106 sends a signal requesting access to system 100. The request is transmitted to one of the existing modules of system 100, either directly to a primary module 101, or through the mesh network of secondary modules 102, 103 to a primary module 101. The request may for example include a unique identifier associated with the additional module 106.

At step 202, the request is transmitted by the primary module 101 to the control server. The control server may be the same as control server 104, or may be a different remote server, such as a dedicated authenticated server.

At step 203, the control server authenticates the additional module 106. For example, the control server may determine whether the unique identifier of the additional module 106 is included in a list of pre-approved modules. Alternatively, the additional module may determine whether the additional module 106 is associated with a third party (e.g. manufacturer, installer) who is approved to add modules to the system 100.

At step 204, the control server transmits, to the or a primary module 101, a confirmation signal indicating that the additional module 106 is authorised to access the system 100.

At step 205, the primary module 101 relays (possibly through one or more secondary modules 102, 103 of the mesh network) the confirmation signal to the additional module 106.

At step 206, the additional module 106 receives the confirmation signal, and becomes part of the system 100. For example, additional module 106 may function as a relay module 102 or node module 103 within the mesh network, or may function as an additional primary module 101 if it has a LPWAN communications link to a or the control sever 104.

Returning to FIG. 1, it is to be appreciated that the arrangement and communication links shown are exemplary only. The system 100 may comprise any number of primary modules 101, and secondary modules 102, 103. Any of the modules 101-103 may be vehicle detectors/parking sensors, or other smart city devices. In some embodiments, none of the modules 101-103 may be parking sensors. Any of the modules 101-103 may be multi-function modules, for example comprising a parking sensor and a smart city device such as an air quality sensor. In some embodiments, the distance between one secondary module 102, 103 and a neighbouring secondary module 102, 103 may be in the range 5-25 m. A primary module 101 may be used for every 25-100 secondary modules, depending on the arrangement of devices. In this way, the system 100 can stretch over large city areas, covering distances of 1 km or more with relatively few primary connections to the server. However, for extra redundancy and to ensure data is transmitted speedily to the server, it has been found that two primary modules 101 per cluster of modules is preferable, a cluster of modules comprising up to 198 secondary modules 102, 103 (for a total of 200 modules in total per cluster).

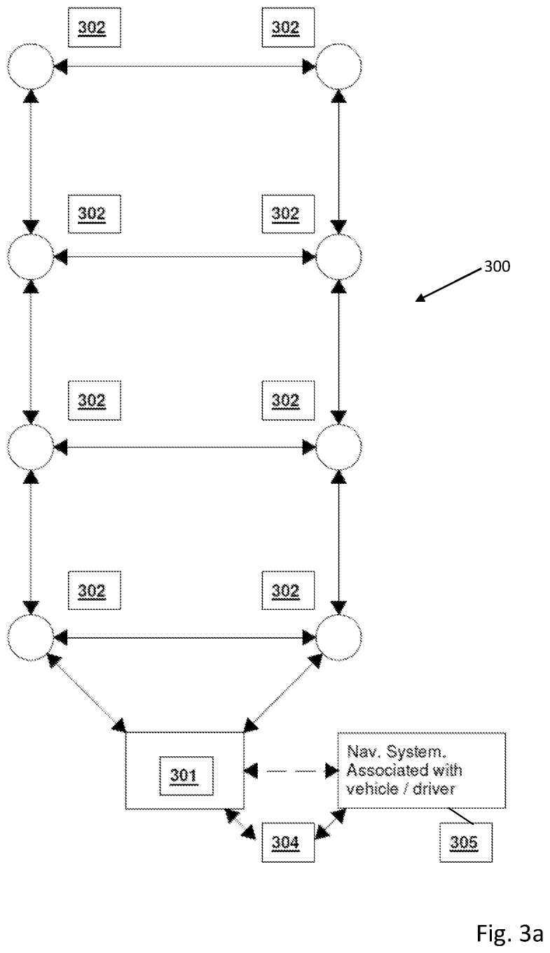

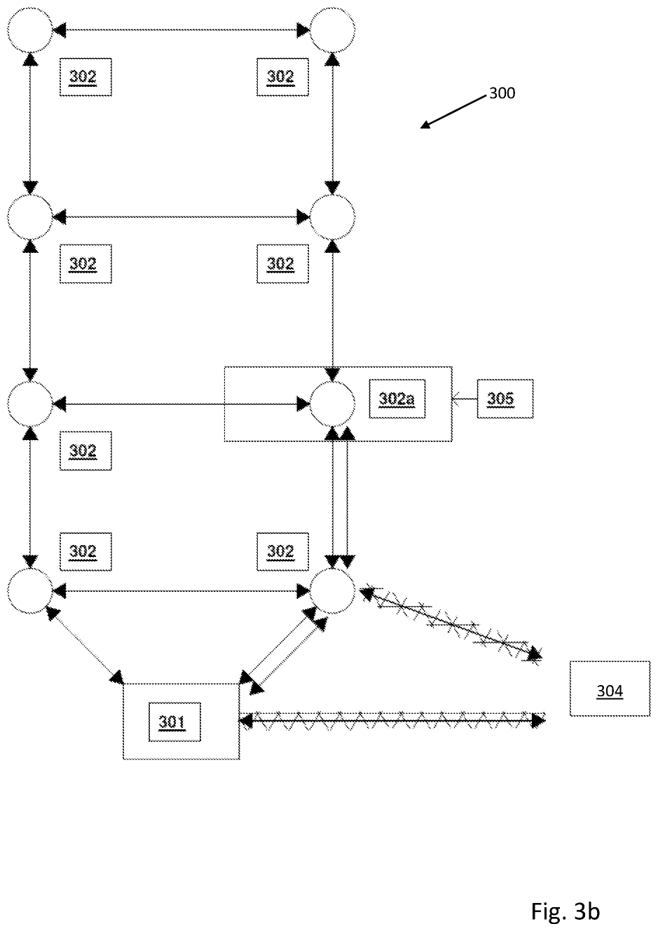

A particularly beneficial use of a street management system such as system 100 is in directing vehicles to available parking spaces. FIGS. 3a and 3b illustrate the operation of an IOT mesh/street management system 300 for such a purpose.

IOT mesh/street management system 300 comprises at least one primary module 301, and secondary modules 302, similar to the modules of system 100 discussed above. For simplicity of illustration, all the modules 301, 302 in system 300 are vehicle sensors, configured to detect the presence of a vehicle in a parking space. In other embodiments, the system may comprise other device types, and any number of primary and secondary modules.

Each module 301, 302 transmits a status report to a remote control server 304 via the mesh network and/or LPWAN connection (as discussed above in relation to system 100). Each status report indicates whether a vehicle is present in the parking space associated with the respective module 301, 302. Status reports may for example be transmitted according to a predetermined schedule, when a change is detected (e.g. arrival of a vehicle), and/or upon request by the control server 304 (e.g. when a vehicle requests parking space information).

In FIG. 3a, a vehicle 305 has not yet arrived at a parking space. The control server 304 may communicate with a navigation device associated with the vehicle 305. The navigation device may be an in-car navigation system of the vehicle itself, or may be (or may be incorporated into) a portable electronic device of an occupant of the vehicle 305, such as the driver. Communications between the control server 304 and navigation device may use any wireless communications link, for example communicating over the internet or via a cellular network. In some embodiments, a primary module 301 may also be capable of communicating directly with a vehicle 305 via a LPWAN link, as illustrated in FIG. 3a, for example to direct the vehicle 305 to a parking space without sending instructions first to the control server 304.

An occupant of the vehicle 305, or the vehicle 305 itself, may request, via the navigation device, a parking space from the control server 304. The request may be for a specific parking space, for example a parking space indicated to be available, based on module status reports received by control server 304. Alternatively, the request may ask that a parking space be assigned by the control server 304. For example, the request may specify an intended destination, and the control server 304 may select the nearest (in time or distance) available parking space based on the received status reports from the modules 301, 302. When a parking space has been selected, the control server 304 may transmit navigation instructions to the vehicle 305 (or specifically to the navigation device). The navigation instructions direct the vehicle 305 to the selected parking space.

The process of providing navigation instructions to a parking spot may take place at any stage of the vehicle's journey. For example, a parking space may be selected before the vehicle 305 departs. Alternatively, a parking space may be selected en route. For example, a conventional navigation system may be used to direct the vehicle 305 to the vicinity of an intended destination. When the vehicle 305 is within a predetermined distance/time of the intended destination, a parking space may be selected and navigation instructions may be provided to supersede the general directions to the intended destination. It is possible that a selected parking space may become occupied whilst the vehicle is en route. In such cases, the control server 304 may select an appropriate alternative parking space (e.g. an available parking space that is the shortest journey from the now occupied space). Alternatively the vehicle 305 or occupant thereof may select a different parking space. In either case, the control server 304 may then provide updated navigation instructions to the new parking space.

FIG. 3b illustrates the case where the vehicle 305 has arrived at a parking space associated with a particular module 302a. Module 302a detects the presence of the vehicle 305, and reports its arrival to the control server 304 via the mesh network and a primary module 301 (illustrated by the double arrows in FIG. 3b). Optionally, the module 302a may also form a direct communication link (e.g. based on the same communications protocol as the mesh network) with the vehicle 305.

Upon receiving the report of arrival, the control server 305 may transmit a notification to the vehicle 305 or its occupant. The notification may for example inform the user of time of arrival at the space, and conditions of using the space. The notification may enable payment for the space. The notification may be based on the geographic location of the parking space, for example it may provide information on local services, or local conditions such as congestion. The notification may be communicated through either the control server's direct communications link with the vehicle 305/occupant's device/navigation system, or via the mesh network of system 300. The latter case may be particularly beneficial where the parking space is in a location where the direct link between the control server 304 and vehicle 305 is not available, for example where cellular communications are not reliable.

The notifications may provide information on the local area to the driver. In a particular example, the notifications may be used to inform the driver of a current Covid-19 alert status for the area, or Covid-19 precaution instructions (e.g. in a hospital setting).

A particular advantage of the present invention is that a very accurate geo-location may be recorded for each module. When installing a module, its actual location may be determined using a positioning system, e.g. GPS. The location may then be stored, for example in a database associated with control server 304. The control server 304 may use a unique identifier of a module to look-up the location of that module in the database. This one-off location determination can be much more accurate than locations determined by devices such as mobile phones or vehicle navigation systems. When a vehicle is confirmed to be at a particular parking spot, the control server 304 therefore can very accurately locate the vehicle 305 based on the location of the respective module 301, 302. This allows, for example, hyper-local customisation of notifications sent to the vehicle.

System 300 may be particularly advantageous for use with autonomous vehicles. Autonomous vehicles may select or request a parking space from system 300, just as a human occupant might. In some situations, however, an autonomous vehicle may be instructed (e.g. by the control server 304) to proceed to a holding spot, for example to reduce congestion in a particular area. System 300 can then be used to confirm that an autonomous vehicle has arrived at a holding spot, and to communicate with the autonomous vehicle based on its location. In such cases, the notification sent by the control server upon determination that the vehicle has arrived at a particular module 302a may be a vehicle control signal, for example setting a time the vehicle must stay in the holding spot.

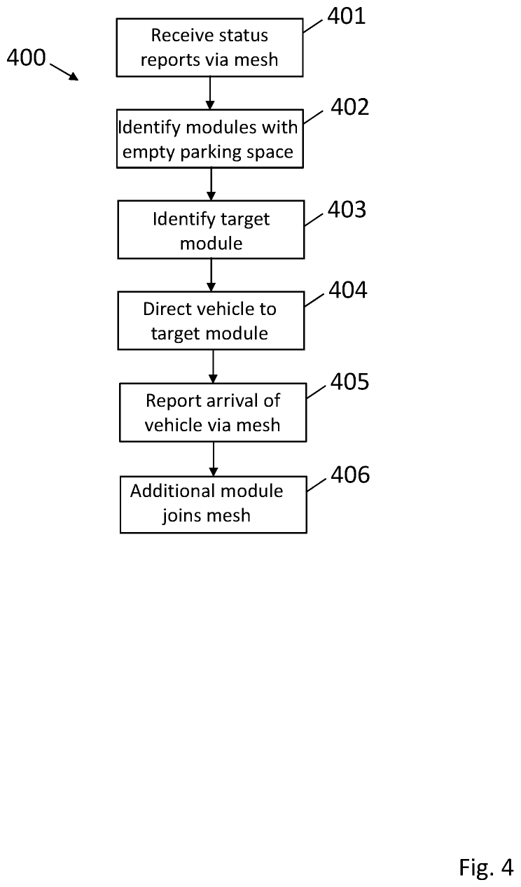

FIG. 4 illustrates a method 400 of directing a vehicle to a parking location, based on a system such as system 100 or 300. Method 400 may be performed by a control server, such as control server 104 or 304.

Method 400 starts at step 401, at which status reports are received from a plurality of secondary modules of an IOT mesh system for smart cities/street management system, the system comprising a plurality of secondary modules and at least one primary module, each status report indicating the presence or absence of a vehicle at a parking location associated with the respective secondary module. As discussed above in relation to FIG. 3, each status report is received via a wireless mesh network formed by the plurality of secondary modules and a primary module, and/or via a LPWAN communication link with the primary module.

At step 402, a sub-set of modules reporting absence of a vehicle are identified. The sub-set of modules may be selected from the full set of modules within the system, or from the set of modules located within a predetermined distance/travel time of an intended destination (e.g. a destination selected by a driver of a vehicle). The sub-set of available modules may be reported to a vehicle or occupant of a vehicle, for example via an application running on a portable electronic device or navigation system of the vehicle.

At step 403 a target module is identified from the sub-set of modules. The target module may be selected automatically by the control server, or may be selected by the vehicle/occupant, as discussed above in relation to FIG. 3. Having identified a target module, the method proceeds to step 404.

Step 404 comprises communicating with a navigation system of the vehicle to direct the vehicle to the target module. For example, navigation instructions may be transmitted to the navigation system via an internet/cellular communications link.

Finally, at step 405, a report is received via the wireless mesh network and LPWAN communication link indicating arrival of the vehicle at the target module. As discussed above in relation to FIG. 3, a notification may then be sent to the vehicle/occupant, for example based on the time of arrival of the vehicle at the parking spot, and/or location of the parking spot.

As will be appreciated by the skilled person, the control server of any example described above may be any computing system capable of communicating with, and sending control signals to, the modules via a LPWAN connection. The control server may be one server, or multiple servers, for example each performing a different function. The multiple servers may be co-located, or may be remote from one another.

Although the invention has been described above with reference to one or more preferred embodiments, it will be appreciated that various changes or modifications may be made without departing from the scope of the invention as defined in the appended claims.

1. An internet of things (IOT) mesh system for smart cities, the system comprising:
at least one primary module for on-street use; and
a plurality of secondary modules configured to communicate with each other and with the at least one primary module using a wireless mesh communications protocol, each secondary module for on-street use;
wherein the at least one primary module is configured to communicate with a control server using a low power wide area network (LPWAN) communications protocol.

2. The system of claim 1, wherein the wireless mesh communications protocol operates in the 2.4 GHz band.

3. The system of claim 1, wherein the at least one primary module, and at least a subset of the plurality of secondary modules are vehicle detectors configured to detect the presence of a vehicle at a location associated with the respective primary or secondary module.

4. The system of claim 1, wherein at least one of the plurality of modules is an air quality monitor, temperature sensor, solar intensity sensor, or other smart city device.

5. The system of claim 1, wherein the system is configured to:
receive a request from an additional module to access the system;
authenticate, via one of the at least one primary modules, the additional module with the control server;
receive, via one of the at least one primary modules, confirmation from the control server that the additional module is authenticated; and
allow the additional module to access the system as a secondary module.

6. The system of claim 3, the system further comprising the control server, wherein:
the control server is configured to communicate with a navigation system associated with a first vehicle, or an occupant of the first vehicle, to direct the first vehicle to a specified module of the at least one primary modules and plurality of secondary modules; and
the specified module is configured to detect arrival of the first vehicle at a location associated with the specified module, and to report the arrival of the first vehicle to the control server.

7. The system of claim 6, wherein upon receipt of the report of arrival of the first vehicle, the control server is configured transmit a notification to the first vehicle, or to a user of the first vehicle.

8. The system of claim 7, wherein the notification is dependent upon at least one of: the location of the specified module, and a time of arrival of the first vehicle at the specified module.

9. The system of claim 8, wherein the notification is dependent upon the location of the specified module, wherein the control server is configured to:
determine an identifier of the specified module;
determine a geographical location associated with the identifier; and
generate a notification based at least in part on the determined geographical location.

10. The system of claim 6, wherein the specified module is selected by the control server from the at one least primary module and plurality of secondary modules based on status reports received from each of the at one least primary module and plurality of secondary modules, each status report indicating the presence or absence of a vehicle in a respective location associated with a respective primary or secondary module.

11. The system of claim 6, wherein the specified module is selected by the occupant of the first vehicle.

12. The system of claim 6, wherein the specified module is a secondary module, and wherein:
the secondary module is configured to transmit a status report indicating arrival of the first vehicle to a nearest primary module via one or more intermediary secondary modules in accordance with the wireless mesh communications protocol; and
the nearest primary module is configured to, upon receipt of the status report indicating arrival of the first vehicle, transmit the status report to the control server using the LPWAN communications protocol.

13. A method of directing a vehicle to a parking location, the method comprising:
receiving status reports from a plurality of modules of an internet of things (IOT) mesh system, the IOT mesh system comprising a plurality of secondary modules and at least one primary module, each status report indicating the presence or absence of a vehicle at a parking location associated with the respective secondary module, wherein:
at least one status report is received from a secondary module via a wireless mesh network formed by the plurality of secondary modules and a primary module, and via a low power wide area network (LPWAN) communication link with the primary module;
identifying a sub-set of modules reporting absence of a vehicle;
identifying a target module from the sub-set of modules;
communicating with a navigation system of a vehicle to direct the vehicle to the target module; and
receiving, via the wireless mesh network and LPWAN communication link, a report indicating arrival of the vehicle at the target module.

14. The method of claim 13, wherein identifying a target module from the sub-set of modules comprises:
receiving, from the navigation system associated with the vehicle, a request for parking at an intended destination;
selecting one of the sub-set of modules based on distance or travel time between the selected module and the intended destination; and
identifying the selected module as the target module.

15. The method of claim 13, wherein identifying a target module from the sub-set of modules comprises receiving, from the navigation system associated with the vehicle, a request for parking, wherein the request specifies the target module.
